(19) United States
(12) Patent Application Publication
(10) Pub. No.: US 2007/0262049 A1
(43) Pub. Date: Nov. 15, 2007

(54) Imprinting method and nano-imprinting apparatus

(75) Inventors: Fumio Miyajima, Chikuma-shi (JP); Kazuhiko Kobayashi, Chikuma-shi (JP); Kazuhiko Kobayashi, Chikuma-shi (JP); Hideaki Nakazawa, Chikuma-shi (JP); Naoya Gotoh, Chikuma-shi (JP); Masahiko Fujisawa, Chikuma-shi (JP); Akira Katsuyama, Chikuma-shi (JP); Shuji Ide, Chikuma-shi (JP)

Correspondence Address: BIRCH STEWART KOLASCH & BIRCH, PO BOX 747, FALLS CHURCH, VA, 22040-0747, US

(73) Assignee: Apic Yamada Corporation

(21) Appl. No.: 11/798,447

(22) Filed: May 14, 2007

(30) Foreign Application Priority Data
May 15, 2006 (JP) 2006-134795

(51) Int. Cl. B44C 1/22; B29C 33/40

(52) U.S. Cl. 216/11; 264/219; 264/284; 425/174

(57) ABSTRACT

An imprinting method carries out imprinting on a workpiece by clamping UV-curable resin between a nano-imprinting mold and a workpiece and curing the UV-curable resin using UV light. In this method, the workpiece is supported on a setting table provided with through-holes that are disposed in a planar region of the setting table on which the workpiece is set and are connected to a gas pumping/evacuating mechanism. The UV-curable resin is supplied onto the workpiece and the setting table is raised to and stopped at a filling operation position where the mold surface of the nano-imprinting mold and the surface of the workpiece are apart. After this, gas is pumped toward the lower surface of the workpiece from the through-holes and the workpiece is pressed onto the nano-imprinting mold from a center of the workpiece toward a periphery of the workpiece while gradually filling the UV-curable resin between the nano-imprinting mold and the workpiece. The UV-curable resin is cured by irradiating the UV-curable resin with UV light in a state where the workpiece is pressed onto the nano-imprinting mold by the pumping pressure of the gas.

### BACKGROUND OF THE INVENTION

1. Field of the Invention

The present invention relates to an imprinting method and a nano-imprinting apparatus used when manufacturing a semiconductor wafer or the like.

2. Related Art

An imprinting method, where a nano-imprinting mold, on whose surface a predetermined convex/concave pattern is formed, is pressed onto a processed member such as a semiconductor wafer or an optical disk to transfer the convex/concave pattern of the nano-imprinting mold to a workpiece, is used as a method of forming an electronic circuit or a dot pattern. The patterns formed on a semiconductor wafer, an optical disk, and the like have an increasingly high density and are now being formed at nanometer level. To form a printing surface on a nano-imprinting mold that is capable of forming this type of minute pattern, an extremely fine convex/concave pattern is formed using an X-ray lithography apparatus or an electron beam.

One method of transferring a convex/concave pattern from a nano-imprinting mold to a workpiece applies resin to the surface of the workpiece and applies pressure to the resin via the nano-imprinting mold to transfer the imprinting pattern to the surface of the workpiece. Here, a thermoplastic resin, a thermocurable resin, a UV curable resin, or the like is used as the resin for transferring the pattern. When a thermoplastic resin is used, transferring is carried out after heating to the glass transition point or above. When a thermocurable resin is used, transferring is carried out after heating to the curing temperature or above. When a UV-curable resin is used, UV light is shone so as to pass through the nano-imprinting mold in a state where the resin is clamped by the nano-imprinting mold, thereby curing the resin and transferring the convex/concave pattern.

After a convex/concave pattern has been formed on the surface of a workpiece using a resin material, the concave parts of the convex/concave pattern (i.e., the parts where the resin is thin) are removed by etching to form a pattern of convex parts on the surface of the workpiece. Next, the workpiece is etched with the pattern of convex parts as a mask to form concave parts in the surface of the workpiece. This imprinting method is used for a process that forms grooves in the surface of a glass substrate or forms a module substrate, semiconductor chip, or magneto-optical disk (see for example Patent Documents 1 to 4).

### Patent Document 1

Japanese Laid-Open Patent Publication No. 2003-272998

### Patent Document 2

Japanese Laid-Open Patent Publication No. 2005-354017

### Patent Document 3

Japanese Laid-Open Patent Publication No. 2005-339669

### Patent Document 4

Japanese Laid-Open Patent Publication No. 2005-353926

### SUMMARY OF THE INVENTION

As described earlier, a nano-imprinting mold has a convex/concave pattern formed with extremely high precision on a mold surface thereof, and when a convex/concave pattern is transferred to a semiconductor wafer, the substrate of an optical disk, or the like, it is necessary to avoid any positional displacements between the workpiece and the nano-imprinting mold and to reliably fill the transfer material such as resin in accordance with the convexes and concaves of the nano-imprinting mold.

The present invention was conceived to solve the problems described above and it is an object of the present invention to provide an imprinting method and a nano-imprinting apparatus that can carry out accurate imprinting on a workpiece such as a semiconductor wafer or a glass substrate.

To achieve the stated object, an imprinting method according to the present invention carries out imprinting on a workpiece and includes steps of: supporting a workpiece on a lower base of a support frame unit, which includes the lower base and an upper base fixed to tie bars erected on the lower base, and supporting a nano-imprinting mold on the upper base so that the workpiece and the nano-imprinting mold can be relatively moved toward and away from one another; a step of supplying a UV-curable resin onto a surface of the workpiece supported on the lower base and then relatively moving the workpiece and the nano-imprinting mold so as to approach one another so that a mold surface of the nano-imprinting mold and the surface of the workpiece contact one another and the UV-curable resin is filled between the workpiece and the nano-imprinting mold; and curing the UV-curable resin by irradiating the UV-curable resin with UV light. Here, imprinting is carried out by relatively moving the workpiece and the nano-imprinting mold toward and away from one another and curing the UV-curable resin using light with the UV-curable resin supplied onto the workpiece clamped by the nano-imprinting mold.

Also, the workpiece may be supported on a setting table and through-holes that are connected to a pumping/evacuating mechanism for gas may be provided in a planar region of the setting table on which the workpiece is set. After the UV-curable resin has been supplied onto the workpiece, one of the setting table and the nano-imprinting mold may be moved to and stopped at a filling operation position where the mold surface of the nano-imprinting mold and the surface of the workpiece are apart. Gas may be pumped toward a lower surface of the workpiece from the through-holes provided in the setting table by the pumping/evacuating mechanism and the workpiece may be pressed onto the nano-imprinting mold from a center of the workpiece toward a periphery of the workpiece while gradually filling the UV-curable resin between the nano-imprinting mold and the workpiece. Also, the UV-curable resin may be cured by irradiating the UV-curable resin with UV light in a state where the workpiece is pressed onto the nano-imprinting mold by pumping pressure of the gas. By imprinting according to a method that presses the workpiece onto the nano-imprinting mold using the pressure of pumped gas, it is possible to carry out imprinting across the nano-imprinting mold and to eliminate fluctuations for the workpiece such as fluctuations in the thickness of the workpiece so that imprinting is carried out with high precision.

Here, a plurality of through-holes that are connected to the pumping/evacuating mechanism for gas may be provided in the planar region of the setting table on which the workpiece is set, and when gas is pumped from the through-holes to a lower surface of the workpiece, the gas may start to be pumped from a through-hole provided in the center of the setting table and then be successively pumped from the through-holes located further out on the setting table. By doing so, it is possible to carry out imprinting with the UV-curable resin reliably filled between the workpiece and the nano-imprinting mold.

When the gas is pumped from the through-holes to a lower surface of the workpiece, the gas may start to be pumped in a state where an outer edge of the workpiece is held by vacuum suction on the setting table. By doing so, it is possible to carry out imprinting on the workpiece even more reliably.

Here, as the workpiece, a workpiece that has a collection channel for preventing the UV-curable resin from overflowing from the workpiece when the UV-curable resin is filled between the workpiece and the nano-imprinting mold formed at an outer circumferential edge thereof may be used. When doing so, by curing the UV-curable resin that has collected into the collection channel using light, it is possible to prevent contamination of the resin, such as when the workpiece is conveyed. It is also possible to wash the UV-curable resin that has collected in the collection channel in a separate process.

A nano-imprinting apparatus that carries out imprinting using the imprinting method described above includes: a support frame unit including a lower base and an upper base fixed to tie bars erected on the lower base; a nano-imprinting mold supported on the upper base; a setting table that is supported on the lower base and in which a plurality of through-holes are provided in a planar region on which a workpiece is set; a raising/lowering mechanism that raises and lowers one of the nano-imprinting mold and the setting table; a pumping/evacuating mechanism for gas that is connected to the through-holes and pumps gas and evacuates gas via the respective through-holes individually; and a control unit for carrying out control that (i) drives, after the UV-curable resin has been supplied onto the workpiece, the raising/lowering mechanism to move one of the setting table and the nano-imprinting mold and to stop the one of the setting table and the nano-imprinting mold at a filling operation position where the mold surface of the nano-imprinting mold and the surface of the workpiece are separated, (ii) causes the pumping/evacuating mechanism for gas to start pumping the gas toward a lower surface of the workpiece from the through-holes provided in the setting table, (iii) next causes the pumping/evacuating mechanism to pump the gas successively from through-holes located further outside to press the workpiece onto the nano-imprinting mold from a center of the workpiece toward a periphery of the workpiece while gradually filling the UV-curable resin between the nano-imprinting mold and the workpiece, and (iv) has the UV-curable resin cured and imprinted by irradiating the UV-curable resin with UV light in a state where the workpiece is pressed onto the nano-imprinting mold by pumping pressure of the gas.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a diagram useful in explaining the overall construction of one embodiment of a nano-imprinting apparatus;

FIG. 2 is a cross-sectional view showing the construction of a setting table and a nano-imprinting mold;

FIG. 3 is a cross-sectional view of a state where air is pumped to a lower surface of a workpiece;

FIG. 4 is a cross-sectional view of a state where the workpiece is pressed onto the nano-imprinting mold by air pressure;

FIG. 5 is a cross-sectional view showing an enlargement of a state where air is pumped to the lower surface of the workpiece;

FIG. 6 is a cross-sectional view showing an enlargement of a state where the workpiece is pressed onto the nano-imprinting mold;

FIGS. 7A to 7C are cross-sectional views showing a state where a UV-curable resin has been attached to the surface of the workpiece;

FIG. 8 is a speed control profile when the setting table is raised;

FIG. 9 is a diagram useful in explaining a planar layout of through-holes and the like on a support plate;

FIGS. 10A and 10B are a plan view and a side cross-sectional view showing another example of a setting table;

FIG. 11 is an enlarged cross-sectional view showing the construction of the nano-imprinting mold;

FIGS. 12A and 12B are plan views showing examples of nano-imprinting molds;

FIG. 13 is a plan view of a state where the nano-imprinting mold is supported by a rectangular frame;

FIG. 14 is a cross-sectional view showing the construction of a collection channel provided on a workpiece; and

FIGS. 15A and 15B are diagrams useful in explaining the relationship between the gap between the workpiece and the nano-imprinting mold and the filler diameter.

### DESCRIPTION OF THE PREFERRED EMBODIMENTS

Preferred embodiments of the present invention will now be described in detail with reference to the attached drawings.

### Overall Construction of a Nano-Imprinting Apparatus

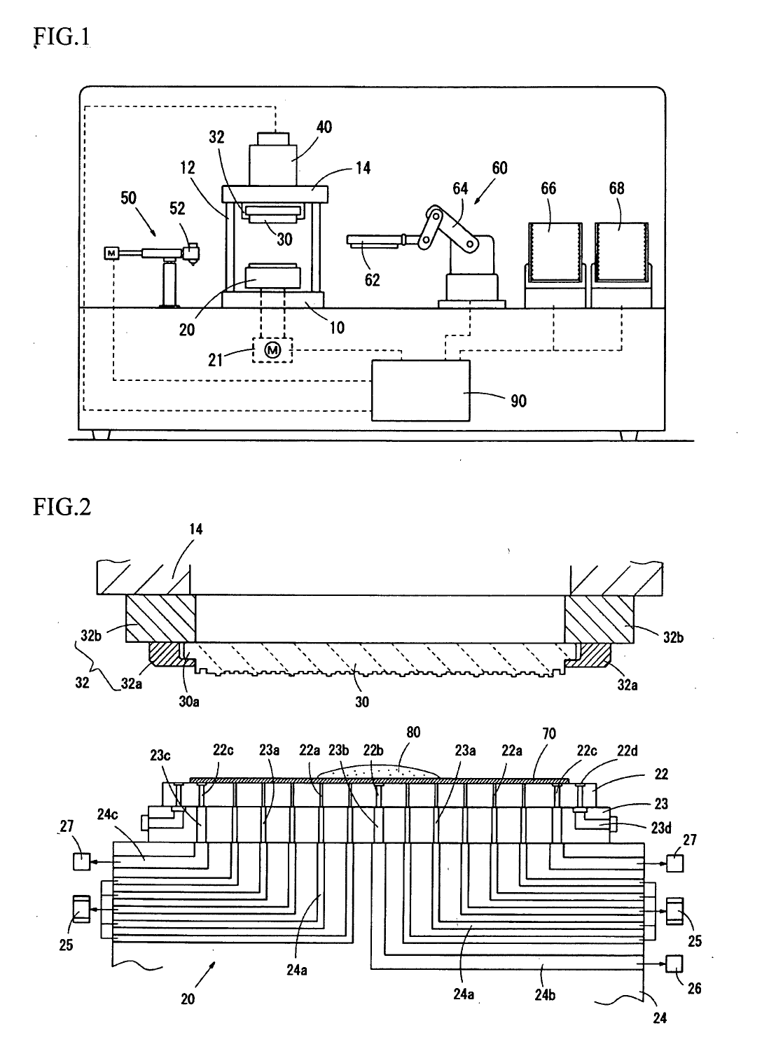

FIG. 1 is a diagram useful in explaining the overall construction of one embodiment of a nano-imprinting apparatus according to the present invention. The nano-imprinting apparatus according to the present embodiment includes a support frame unit, which is composed of a lower base 10 and an upper base 14 that is fixed to upper parts of tie bars 12 erected on the lower base 10, and an imprinting operation unit composed of a setting table 20 supported on the lower base 10, a nano-imprinting mold 30 that is supported on the upper base 14 by a mold frame holder 32, and a UV light source 40 that shines UV light from above the nano-imprinting mold 30.

In the support frame unit, the lower base 10 and the upper base 14 are supported by the tie bars 12 fixed to the lower base 10 so that the lower base 10 and the upper base 14 are aligned and supported facing one another with high precision.

The setting table 20 supports a workpiece such as a semiconductor wafer or glass substrate that is set thereupon. The setting table 20 is raised and lowered using a raising/lowering mechanism including a motor 21 or the like disposed below the lower base 10 and can be aligned with the nano-imprinting mold 30 by a fine adjustment mechanism in the X-Y-θ directions.

A supplying apparatus 50 that supplies UV-curable resin (hereinafter simply “UV resin”) as a transfer material onto the workpiece is disposed on one side of the support frame unit. The supplying apparatus 50 includes a dispenser 52 that supplies a measured amount of the UV resin to the workpiece.

A conveying mechanism 60 that conveys a workpiece such as a semiconductor wafer or a glass substrate onto and off the setting table 20 is provided on the other side of the support frame unit. The conveying mechanism 60 includes a suction pad 62, which supports the workpiece by air suction, and a robot hand 64. The conveying mechanism 60 carries out an operation that conveys the workpiece 70 from a loader magazine 66 disposed beside the conveying mechanism 60 and stores the workpiece 70 after processing in an offloader magazine 68.

### Construction of the Imprinting Operation Unit

FIG. 2 is a cross-sectional view showing the construction of the setting table 20 that is the characteristic construction of the nano-imprinting apparatus and the construction of the mold frame holder 32 or the like that supports the nano-imprinting mold 30.

The setting table 20 that supports the workpiece 70 is composed of a support plate 22 that supports the workpiece 70, an intermediate plate 23 that supports the support plate 22, and a base plate 24. Through-holes 22a, 23a that pass through the support plate 22 and the intermediate plate 23 in the thickness direction are provided in the support plate 22 and the intermediate plate 23, and connecting channels 24a, 24b are provided in the base plate 24.

Since the support plate 22 is circular in planar form, as shown in FIG. 9, many through-holes 22a are provided so as to radiate out from the center of the support plate 22 in a planar region of the support plate 22 where the workpiece 70 is set. The through-holes 22a, 23a are provided at the same positions in the planar regions of the support plate 22 and the intermediate plate 23 so as to be connected. The connecting channels 24a are connected to the through-holes 23a at one end and are open on a side surface of the base plate 24 at the other end. These connecting channels 24a are connected to an air mechanism 25 as a pumping/evacuating mechanism for gas. The air mechanism 25 is controlled so as to carry out operations that separately pump air and evacuate air to and from the respective connecting channels 24a individually.

A main through-hole 22b is provided in the center of the support plate 22 and is connected via a through-hole 23b and a connecting channel 24b to an air mechanism 26 as a pumping/evacuating mechanism for gas. As shown in FIG. 9, the main through-hole 22b is formed with a slightly larger diameter than the through-holes 22a.

Air suction holes 22c are provided in the support plate 22 so that the workpiece 70 is supported by evacuating air at an outer edge of the workpiece 70. The air suction holes 22c are connected to an air evacuating mechanism 27 via through-holes 22c and connecting channels 24c.

A discharge channel 22d for discharging the UV resin as the transfer material is provided so as to circle the support plate 22 at a position outside the region of the support plate 22 on which the workpiece 70 is set. The discharge channel 22d is connected to a discharge channel 23d provided in the intermediate plate 23 and the discharge channel 23d is provided so that one end thereof is open to the side surface of the intermediate plate 23. The discharge channel 22d is provided so as to discharge UV resin that has overflowed.

FIG. 9 shows the planar layout of the main through-hole 22b and the discharge channel 22d. The main through-hole 22b is provided at one position in the center of the support plate 22.

The mold frame holder 32 includes a locking portion 32a that supports and locks a flange portion 30a provided on the outer circumferential surface of the nano-imprinting mold 30 and a holder portion 32b that supports the locking portion 32a. The holder portion 32b is provided with a wide opening on a rear surface side thereof so as to allow UV light to be transmitted through the nano-imprinting mold 30. An opening for allowing UV light to be transmitted is also provided in the upper base 14.

A process that forms the required convexes and concaves is carried out on a mold surface of the nano-imprinting mold 30 to form the required convex/concave pattern. The construction of the nano-imprinting mold 30 is described in detail later in this specification.

### Imprinting Operation

Next, the processes of an imprinting operation carried out on the workpiece 70 using the nano-imprinting apparatus shown in FIGS. 1 and 2 will be described. Note that the various components of the nano-imprinting apparatus are controlled by a control unit 90 to carry out the required operations.

First, according to control by the control unit 90, the motor 21 is controlled and driven to lower the setting table 20 to a lower position where the workpiece 70 is supplied to the setting table 20. The operation that supplies the workpiece 70 to the setting table 20 is carried out by picking up a workpiece 70 that protrudes from the loader magazine 66 on the suction pad 62 using suction and supplying the workpiece 70 to the setting table 20 using the robot hand 64.

After the workpiece 70 has been placed on the support plate 22, the air mechanism 25 and the air evacuating mechanism 27 are used to support the workpiece 70 on the setting table 20 by suction, and then the workpiece 70 is aligned with the nano-imprinting mold 30. This aligning operation can be carried out for example by optically detecting alignment marks provided on the workpiece 70 and then aligning the setting table 20 using the fine adjustment mechanism in the X-Y-θ directions in accordance with the detection result for the alignment marks.

Next, UV resin 80 is supplied on to the workpiece 70 by the UV resin supplying apparatus 50. The supplied amount of the UV resin 80 exceeds the amount required to fill the concave parts of the nano-imprinting mold 30 when the UV resin 80 is clamped by the workpiece 70 and the nano-imprinting mold 30 by around 20%.

The supplied amount and applied shape of the UV resin 80 supplied to the workpiece 70 can be appropriately adjusted via the planar form of the workpiece 70 and the like, but in view of the operability and the molding variation during mass production, by carrying out molding by supplying an amount of resin produced by adding an overflow amount to the minimum amount of resin required for molding, it is possible to stabilize the molding quality of the outer circumferential part of the workpiece 70. Note that it is necessary to determine the overflow amount of resin in accordance with the workpiece 70 with consideration to factors such as the flow characteristics of resin on the surface of the workpiece 70.

Although the UV resin 80 is supplied to the workpiece 70 so that the planar form of the supplied UV resin 80 is fundamentally circular, there are cases where the shape in which the UV resin 80 spreads out is distorted and is not circular due to factors such as the planar form of the workpiece 70 and patterns formed on the workpiece 70. Accordingly, it is possible to feed back molding results to adjust the shape in which the UV resin 80 is applied and/or to supply the UV resin 80 so that the applied UV resin 80 is higher (i.e., thicker) in the center. By increasing the supplied amount of resin with consideration to the amount that will overflow, it will be possible to fill the concave parts with the UV resin 80 without leaving unfilled areas.

Depending on the pattern formed on the surface of the workpiece 70, it may also be effective to apply the UV resin by dispersing the UV resin in a cross shape or in many dots.

FIG. 2 shows a state where the workpiece 70 has been set on the support plate 22 of the setting table 20 in a state where the setting table 20 is at the lower position (i.e., at the position where the workpiece is conveyed and the UV resin supplying operation is carried out) and where UV resin 80 has been supplied onto the workpiece 70. The UV resin 80 is supplied to substantially the center of the workpiece 70. The UV resin 80 exhibits fluidity, and by supplying the UV resin 80 by spotting on the workpiece 70, the UV resin 80 will become slightly raised up due to surface tension.

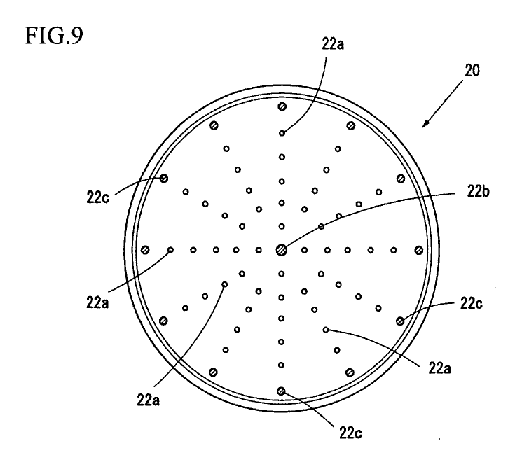

After the UV resin 80 has been supplied, the motor 21 is driven to raise the setting table 20. FIG. 8 shows a method of controlling the speed when raising the setting table 20. That is, when the raising of the setting table 20 starts, the setting table 20 is raised in accordance with a required raising speed. However, just before the UV resin 80 that has been supplied onto the workpiece 70 comes into contact with the nano-imprinting mold 30, the raising speed is lowered so as to fall to a required compression start speed when the UV resin 80 contacts the nano-imprinting mold 30. This is carried out because if the UV resin 80 were placed in contact with the nano-imprinting mold 30 without slowing the setting table 20, it would not be possible to reliably fill the nano-imprinting mold 30 with the resin due to shock waves occurring at the resin surface. The expression “compression start speed” refers to a speed set slower than the raising speed of the setting table 20 and corresponds to the average flow speed of the flow front of the resin. As a result, it is possible to prevent the production of shock waves at the moment when the fluid level of the resin contacts the mold surface of the nano-imprinting mold 30. Here, after the raising speed of the setting table 20 has been reduced to below the compression start speed, it is possible to slightly raise the raising speed of the setting table 20 to slightly above the compression start speed.

When the distance of separation between the mold surface of the nano-imprinting mold 30 and the surface of the workpiece 70 is 0.005 μm to 1 μm, the setting table 20 is stopped. This position is the height of the setting table 20 at which the imprinting operation is finally carried out.

The imprinting operation of the present embodiment is characterized by the upper position (i.e., the “filling operation position”) to which the setting table 20 is raised being set so that a gap is provided between the surface of the workpiece 70 and the nano-imprinting mold 30 and therefore the surface of the workpiece 70 does not completely contact the mold surface of the nano-imprinting mold 30. Since the thickness of the workpiece 70 differs between products, the distance of separation provided between the support plate 22 of the setting table 20 and the nano-imprinting mold 30 will differ depending on the workpiece 70.

Note that since there are fluctuations in the thickness of the workpiece 70, the thickness of the workpiece 70 is detected in advance, the detection result is transferred to the press, and the stopping position is controlled for each workpiece 70 so that the separation provided between the nano-imprinting mold 30 and the workpiece 70 is set within a range of predetermined values.

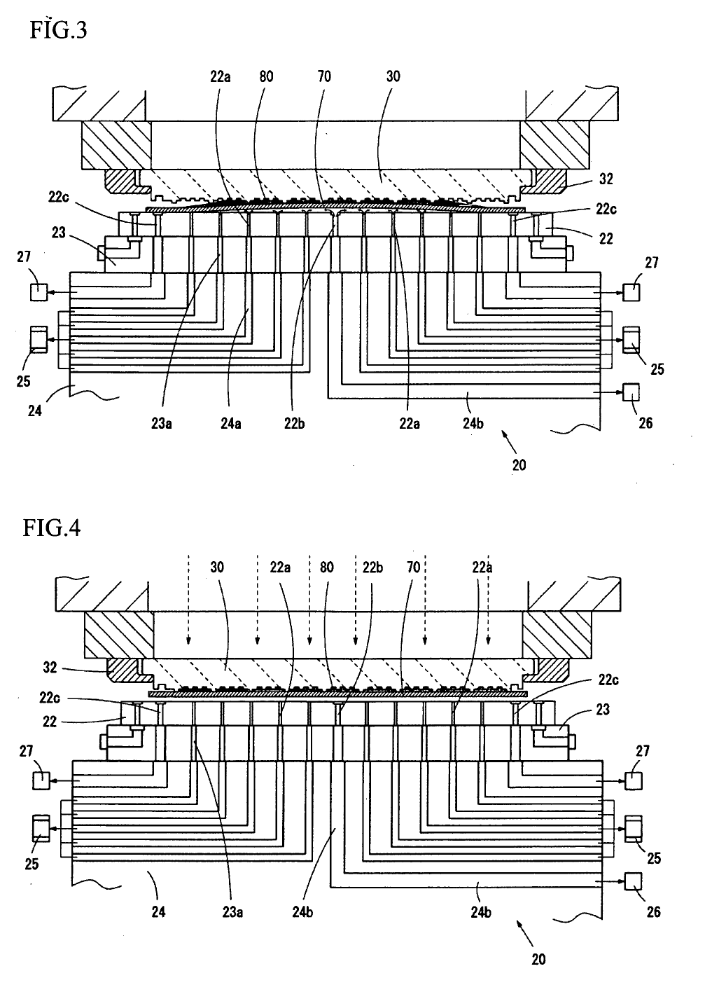

After the setting table 20 has been stopped at the upper position (the filling operation position), the air mechanisms 25, 26 are driven to pump air toward the lower surface of the workpiece 70 supported on the support plate 22. FIG. 3 shows a state where the air mechanisms 25, 26 are operated to pump air to the lower surface of the workpiece 70.

Note that when air is pumped from the air mechanisms 25, 26, the air is first pumped out of the main through-hole 22b positioned in the center of the support plate 22 and is gradually pumped out from the through-holes 22a positioned further out on the support plate 22. For the air mechanism 25, the timing for pumping air is controlled in accordance with the layout of the through-holes 22a. Since the air mechanism 26 pumps air to the main through-hole 22b positioned in the center of the support plate 22, the air mechanism 26 is controlled to pump air before the other through-holes 22a.

As shown in FIG. 3, when air starts to be pumped to the lower surface (i.e., rear surface) of the workpiece 70, the air evacuating mechanism 27 is operated to hold the outer edge of the workpiece 70 by suction on the surface of the support plate 22. The air is pumped to the lower surface of the workpiece 70 in a state where the outer edge of the workpiece 70 is being held and supported by suction so that the workpiece 70 is secured and does not become displaced when air is pumped and also to ensure that a central part of the workpiece 70 contacts the mold surface of the nano-imprinting mold 30 first and that the position where the workpiece 70 and the nano-imprinting mold 30 contact one another gradually moves from the center of the workpiece 70 to the outer edge of the workpiece 70.

By setting the distance of separation between the workpiece 70 and the mold surface of the nano-imprinting mold 30 at around 0.005 μm to 1 μm and blowing air to raise the workpiece 70 while the outer edge of the workpiece 70 is being supported, it is possible to prevent displacement of the workpiece 70 and to reliably press the workpiece 70 onto the nano-imprinting mold 30.

FIG. 4 shows a state where air is pumped to the rear surface of the workpiece 70 so that the workpiece 70 floats above the surface of the support plate 22 and is pressed onto the nano-imprinting mold 30 by air pressure. When air has been pumped from the rear surface of the workpiece 70 and around one half of the planar area of the workpiece 70 has been pressed onto the nano-imprinting mold 30, the air evacuating mechanism 27 is stopped so that the entire workpiece 70 is released from the support plate 22 and becomes pressed onto the nano-imprinting mold 30.

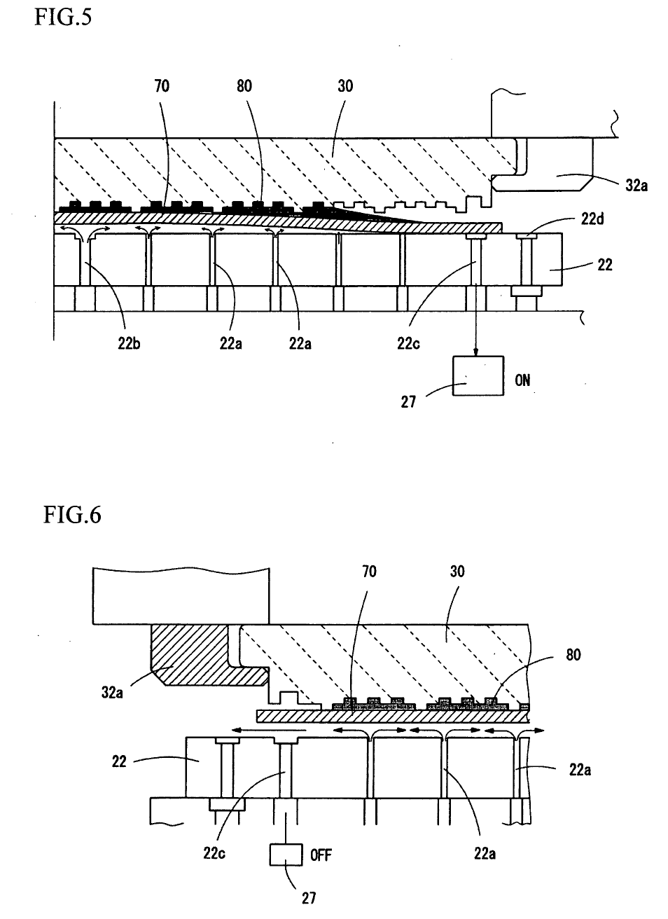

FIGS. 5 and 6 are enlarged views showing how the workpiece 70 is pressed upward from the setting table 20 while air is being pumped to a rear surface of the workpiece 70.

FIG. 5 shows how air is pumped from a center of the workpiece 70 in a state where air is being evacuated from the outer edge of the workpiece 70 by the air evacuating mechanism 27. Here, although the center of the workpiece 70 is pressed onto the mold surface of the nano-imprinting mold 30, the outer edge of the workpiece 70 remains separated from the mold surface of the nano-imprinting mold 30.

FIG. 6 shows a state where the workpiece 70 is pressed onto the nano-imprinting mold 30 by the air pressure of the air expelled from the through-holes 22a so that the UV resin 80 fills the concave parts of the nano-imprinting mold 30 from the center of the workpiece 70 toward the outer edge and the UV resin 80 is filled across the entire surface of the workpiece 70 in a state where the workpiece 70 completely floats above the support plate 22.

UV light is emitted from above the nano-imprinting mold 30 in a state where the workpiece 70 is being pressed onto the nano-imprinting mold 30 by air pressure, resulting in the UV resin 80 being hardened by the UV light transmitted through the nano-imprinting mold 30. By doing so, the UV resin 80 becomes hardened and attached to the surface of the workpiece 70.

After the UV resin 80 has been hardened by irradiation with UV light for a fixed period, the air mechanisms 25, 26 switch to carrying out an evacuating operation that pulls the workpiece 70 by vacuum suction. In this way, by lowering the workpiece 70 to the support plate 22 by suction, the hardened resin 80a and the workpiece 70 become detached from the nano-imprinting mold 30. The setting table 20 is then lowered together with the workpiece 70 to the lowered position (the conveying position).

Next, the robot hand 64 of the conveying mechanism 60 is moved into the imprinting operation unit, the workpiece 70 that has been imprinted is held by the suction pad 62 and the workpiece 70 is stored inside the offloader magazine 68. When the workpiece 70 that has been imprinted is picked up by the suction pad 62 using suction, air is expelled from the air mechanisms 25, 26 to separate the workpiece 70 from the support plate 22 and allow the workpiece 70 to be transferred.

Note that as another method of transporting the imprinted workpiece 70, it is possible to use a method that lowers only the setting table 20 to the lower position after the UV resin 80 has been hardened with the workpiece 70 still adhering to the workpiece 70. The imprinted workpiece 70 is then detached from the nano-imprinting mold 30 and stored in the offloader magazine 68 using the conveying mechanism 60.

In this case, it is possible to lower the setting table 20, to insert the robot hand 64 with the suction surface of the suction pad 62 facing upward, to attach the lower surface of the workpiece 70 to the suction pad 62 by suction, and to then detach the imprinted workpiece 70 by operating the robot. Here, it is possible to detach the entire workpiece 70 from the nano-imprinting mold 30 by tilting the workpiece 70 so that the workpiece 70 is gradually pulled off from one outer edge thereof.

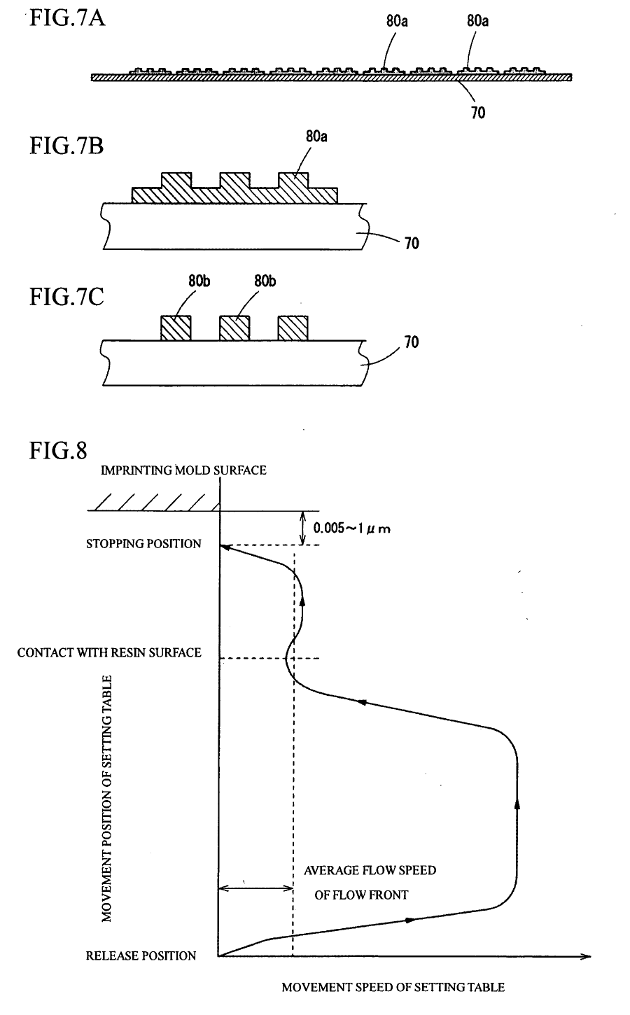

FIGS. 7A to 7C show a state where the hardened resin 80a that has been molded into a convex/concave pattern and hardened is attached to the surface of the workpiece 70. FIG. 7B is an enlargement of one section of the hardened resin 80a. The concave parts of the hardened resin 80a are removed by etching, so that as shown in FIG. 7C, convex parts 80b remain on the surface of the workpiece 70. The surface of the workpiece 70 is then etched with the convex parts 80b as a mask to form a predetermined pattern in the surface of the workpiece 70.

### Effects of the Imprinting Operation

As shown in FIGS. 3 to 6, with the nano-imprinting apparatus according to the present embodiment, when the UV resin 80 is clamped by the nano-imprinting mold 30 and the workpiece 70 after the UV resin 80 has been supplied onto the workpiece 70, instead of clamping the UV resin 80 until the nano-imprinting mold 30 and the workpiece 70 completely contact each other, air pressure is caused to act upon the nano-imprinting mold 30 and the workpiece 70 from the lower surface (i.e., the rear surface) of the workpiece 70 so that the workpiece 70 is pressed onto the mold surface of the nano-imprinting mold 30 by air pressure and the UV resin 80 fills the concave parts of the nano-imprinting mold 30.

The workpiece 70 is pressed onto the nano-imprinting mold 30 using air pressure in this way since it is possible to press the workpiece 70 so that the workpiece 70 assumes the shape of the mold surface of the nano-imprinting mold 30.

When using a mold (such as the nano-imprinting mold 30) in which an extremely minute pattern is formed, if the workpiece 70 were completely pressed onto the mold, fluctuations in the thickness of the workpiece 70 and undulations in the surface of the workpiece 70 would appear as fluctuations in the form of the molded product (i.e., in the form of the UV resin). As a method of eliminating such fluctuations in the workpiece, it is preferable to prevent fluctuations in the workpiece 70 from affecting the imprinted pattern. With the nano-imprinting apparatus according to the present embodiment, the workpiece 70 is pressed so as to assume the shape of the mold surface of the nano-imprinting mold 30, or in other words, the UV resin 80 is imprinted by pressing the workpiece 70 with the mold surface of the nano-imprinting mold 30 as the standard surface, and therefore imprinting is carried out according to a condition where fluctuations in the thickness and non-uniformity of the workpiece 70 are not reflected. That is, the convex/concave pattern of the nano-imprinting mold 30 is accurately transferred to the imprinted UV resin 80.

The present embodiment is set so that when the workpiece 70 is pressed onto the nano-imprinting mold 30, the workpiece 70 starts being pressed onto the nano-imprinting mold 30 from a central part of the workpiece 70 and the pressed part gradually expands to the periphery of the workpiece 70. In this way, by pressing the workpiece 70 toward the nano-imprinting mold 30 from the central part of the workpiece 70, it is possible to fill the UV resin 80 without air becoming trapped in the parts of the nano-imprinting mold 30 that have been filled with resin.

During nano-imprinting using the nano-imprinting mold 30, it is necessary to prevent bending of and/or damage to the nano-imprinting mold 30 due to the action of the resin pressure on the nano-imprinting mold 30 when the resin is molded. When the workpiece 70 is pressed onto the nano-imprinting mold 30 as in the present embodiment, by pressing the workpiece 70 onto the nano-imprinting mold 30 from the central part of the workpiece 70 so as to cause the UV resin 80 to flow from the central part of the workpiece 70 toward the outside, it is possible to prevent the nano-imprinting mold 30 from bending due to resin pressure. If the nano-imprinting mold 30 bends and deforms due to resin pressure, resin will accumulate in spaces produced by the bending and the thickness of the resin can easily vary by as much as 500 nm (0.5 μm) for example, which is one hundred times the intended thickness of 5 nm.

Although air is pumped from both the main through-hole 22b and the through-holes 22a when pumping air to raise the air pressure at the lower surface of the workpiece 70 in the present embodiment, the method of pumping air can be set as appropriate in accordance with the material, size, and the like of the workpiece 70. For example, if the required air pressure can be obtained by pumping air via only the main through-hole 22b, it is possible to carry out imprinting by carrying out control so that air is pumped from only the main through-hole 22b. The positions at which the through-holes 22a for pumping air are provided in the support plate 22 and the like can also be selected as appropriate. When air is expelled from the through-holes 22a, it is possible to appropriately select the through-holes 22a from which air is expelled and to appropriately control the air pressure for each through-hole 22a that is expelling air.

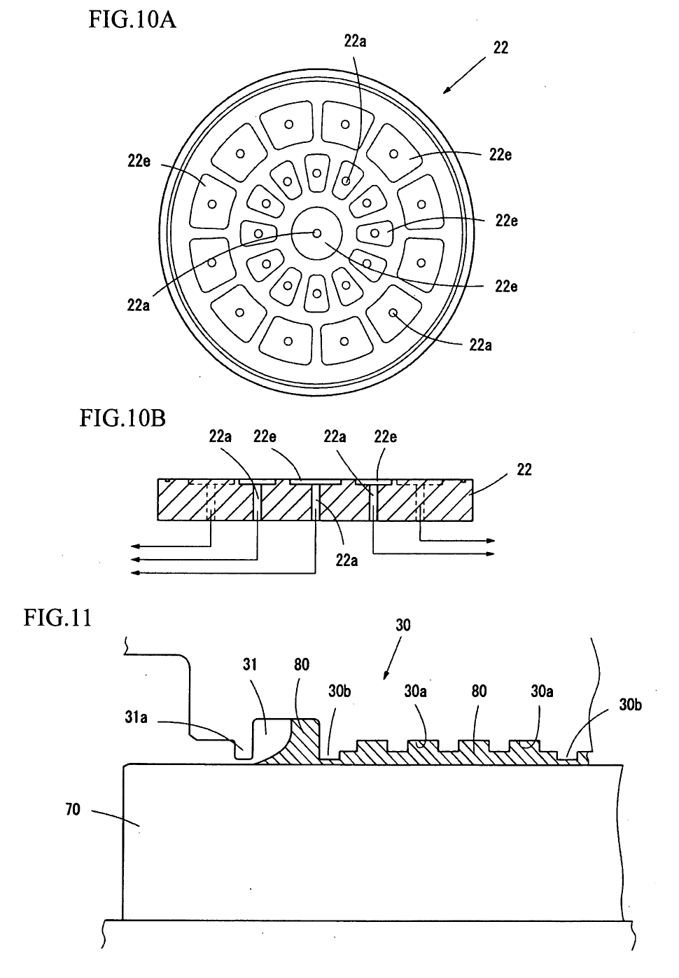

FIGS. 10A and 10B show another example construction of the support plate 22 where a plurality of pockets 22e with flat inner bottom surfaces are provided in the workpiece setting surface of the support plate 22 and the through-holes 22a are provided in the inner bottom surfaces of the respective pockets 22e. In the illustrated example, a circular pocket 22e is provided in the center of the support plate 22 and the other pockets 22e are provided so as to be uniformly laid out around the pocket 22e in the center.

FIG. 10B shows the support plate 22 in cross-section from the side and shows the through-holes 22a passing through the inner bottom surfaces of the pockets 22e and how the individual through-holes 22a are independently connected to an air mechanism.

In the same way as the embodiment described above, with the setting table 20 according to the present embodiment, the workpiece 70 is set on the setting table 20 and air is expelled from the through-holes 22a to press the workpiece 70 onto the nano-imprinting mold 30 by air pressure so that the convex/concave shape of the nano-imprinting mold 30 is imprinted into the UV resin 80.

With the support plate 22 according to the present embodiment, by using a construction where the through-holes 22a are provided in the inner bottom surfaces of the pockets 22e, it is possible to cause the air pressure of the air expelled from the respective through-holes 22a to act across a wider area of the workpiece 70, so that the air pressure acts uniformly on the workpiece 70.

In the present embodiment, in the same way as the embodiment described above, the timing at which air is introduced from the through-holes 22a is controlled so as to implement control so that the contacting part of the nano-imprinting mold 30 and the workpiece 70 gradually increases from the center of the workpiece 70 toward the outer edge of the workpiece 70. The contact between the workpiece 70 and the nano-imprinting mold 30 can be visually confirmed from differences in the angle of reflection of light seen through the nano-imprinting mold 30, and therefore control can be carried out to adjust the timing of introducing air into the individual through-holes 22a and the air pressure of the individual through-holes 22a while monitoring the contact between the workpiece 70 and the nano-imprinting mold 30.

When controlling the contact (i.e., the gap) between the workpiece 70 and the nano-imprinting mold 30, it is necessary to guide the UV resin 80 to the parts that are yet to be filled with the UV resin 80 by using capillary action and to reliably generate an action that guides the air from such unfilled parts toward a low pressure area so as to press the air out from the workpiece 70. This means that a method that controls the air pressure introduced from through-holes 22a to the rear surface of the workpiece 70 while actually detecting the pressing state (i.e., the contact) between the workpiece 70 and the nano-imprinting mold 30 can carry out a reliable imprinting operation with no fluctuations.

Note that although air is used to press the workpiece 70 onto the nano-imprinting mold 30 in the embodiment described above, it is also possible to use nitrogen gas or another gas in place of air.

Also, although a construction is used in the embodiment described above where the support plate 22 and the intermediate plate 23 are used and the through-holes 22a, 23a are provided in the support plate 22 and the intermediate plate 23, flow channels formed in the support plate 22 and the like only need to cause air pressure to act on the workpiece 70 or to evacuate air from the workpiece 70 and therefore it may not be necessary to form through-holes. Through-holes for connecting to mechanisms for pumping and evacuating gas may be provided in the surface of the setting table 20 on which the workpiece 70 is set.

Although imprinting is carried out in the embodiment described above using a construction where it is possible to raise and lower the workpiece 70 with respect to the lower base 10, the nano-imprinting mold 30 is fixed to the upper base 14, and the workpiece 70 is movable with respect to the nano-imprinting mold 30, it is also possible to carry out imprinting with a construction where the workpiece 70 is fixed and the nano-imprinting mold 30 is capable of being raised and lowered. In this case also, it is possible to use an operation where UV-curable resin is filled between the workpiece 70 and the nano-imprinting mold 30, with the workpiece 70 being pressed onto the nano-imprinting mold 30 using the pumping/evacuating mechanism for gas described earlier.

### Construction of the Nano-Imprinting Mold

A mold in whose surface concave channels are formed in a predetermined pattern is used as the nano-imprinting mold. As shown in FIG. 11, a mold in which concave channels 30a of a predetermined pattern and gap-maintaining protrusions 30b for maintaining a gap between the mold surface of the nano-imprinting mold 30 and the surface of the workpiece 70 are formed is used in the present embodiment. The protrusions 30b are formed with a height of around 5 to 10 nm. In this way, by providing the gap-maintaining protrusions 30b on the mold surface of the nano-imprinting mold 30, it is possible to facilitate the filling of UV resin 80 between the nano-imprinting mold 30 and the workpiece 70 when the UV resin 80 is clamped by the nano-imprinting mold 30 and the workpiece 70 and possible to maintain the flow characteristics of the UV resin 80 when the UV resin 80 is sandwiched. As a result, the UV resin 80 can be filled uniformly across the entire workpiece 70. Note that the protrusions 30b can also be formed by a separate member to the nano-imprinting mold 30.

With the nano-imprinting mold 30 used in the present embodiment, a collection channel 31 for collecting the UV resin 80 that has overflowed when the UV resin 80 is clamped is provided so as to surround an outer edge of the nano-imprinting mold 30. FIG. 11 shows how the UV resin 80 that has been pressed out during an imprinting operation is held in the collection channel 31. Since a larger amount of UV resin 80 than is required to fill the concave channels in the nano-imprinting mold 30 is supplied during the imprinting operation in the present embodiment, it is effective to form the collection channel 31 that collects the UV resin 80 that has overflowed.

Although the UV resin 80 flows comparatively quickly across the surface of the workpiece 70 when the UV resin 80 is clamped by the nano-imprinting mold 30 and the workpiece 70, the UV resin 80 trapped in the collection channel 31 will gather inside the collection channel 31, thereby causing a drop in the speed at which the UV resin 80 is discharged to the outside. This means that by forming a trap wall 31a around the outer circumferential surface of the collection channel 31, it is possible to prevent the UV resin 80 from leaking outside the collection channel 31.

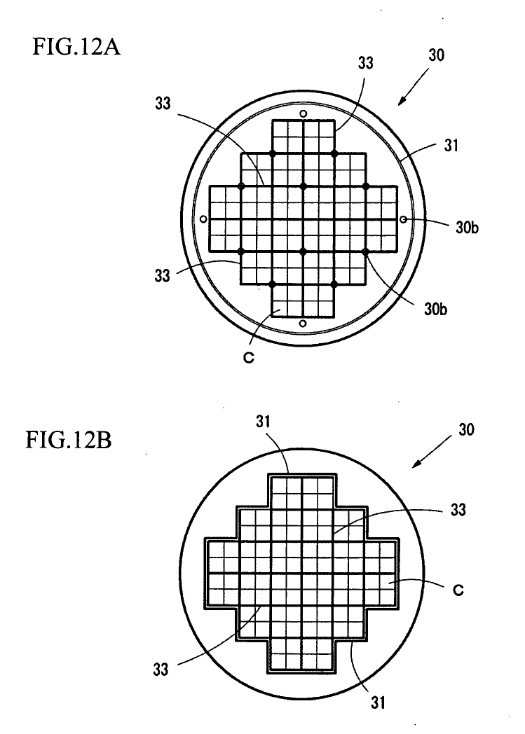

FIGS. 12A and 12B show examples of the planar layout of the nano-imprinting mold 30. The illustrated nano-imprinting molds 30 are used when processing a semiconductor wafer and the drawings show that single sections are formed corresponding to single LSI chips. In FIG. 12A, a circular collection channel 31 is formed so as to surround the formation region of the LSI chips. In FIG. 12B, the collection channel 31 is formed along the outer edge position of the formation region of the LSI chips.

In FIGS. 12A and 12B, reference numeral 33 designates pressing channels for pressing out the UV resin. The pressing channels 33 adjust the flow of the UV resin 80 across the surface of the workpiece 70, and by enabling the flow characteristics to be maintained, act so as to prevent air bubbles from being trapped or enclosed in the UV resin 80 and to reduce the force applied during compression molding. The pressing channels 33 are set wider than the width of the boundaries between adjacent LSI chips when conventionally fabricating a semiconductor wafer, for example, so that the flow characteristics of the UV resin 80 are maintained. The width of the pressing channels 33 are set at around 50 μm or below and the depth of the pressing channels 33 are set at around 10 μm or below. Also, by providing the pressing channels 33 at positions that pass through regions where a plurality of LSIs are formed as shown in FIG. 12A, and by connecting the pressing channels 33 to the collection channel 31 as shown in FIG. 12B, it is possible to effectively discharge the excess UV resin 80.

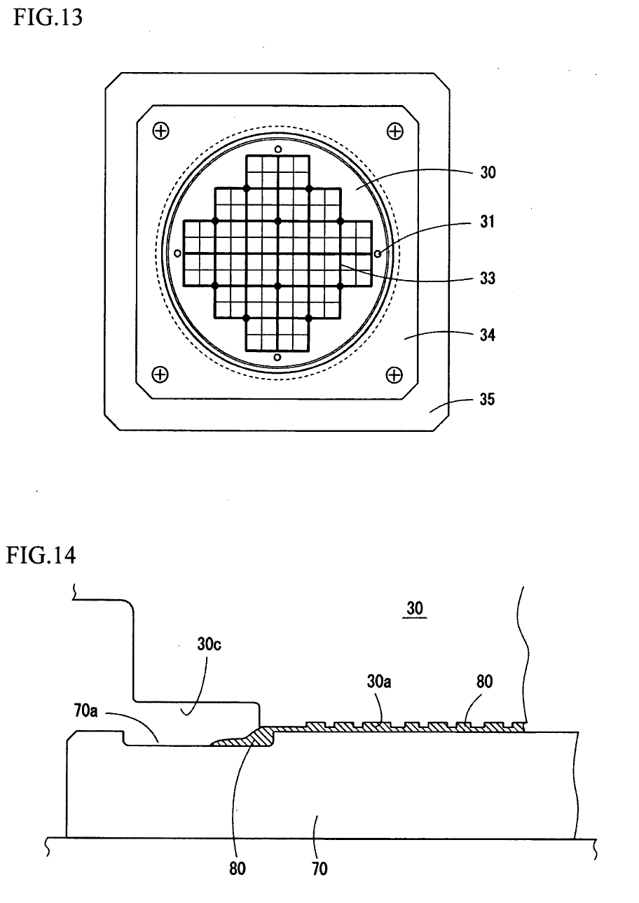

FIG. 13 shows an example where the nano-imprinting mold 30 that is circular in planar form is supported by a rectangular frame 35 when attaching the nano-imprinting mold 30 to the upper base 14 so as to facilitate attachment to the upper base 14 that is formed with a rectangular planar form. The nano-imprinting mold 30 is supported on the rectangular frame 35 by sandwiching the nano-imprinting mold 30 in the thickness direction using two fixing plates 34 in which circular holes with a slightly smaller diameter than the outer diameter of the nano-imprinting mold 30 are formed and fixing the two fixing plates 34 together.

### Construction of the Workpiece

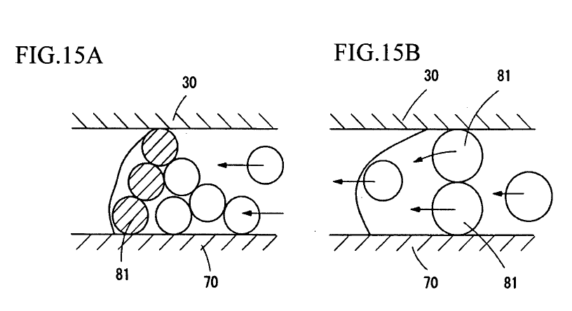

FIG. 14 is a cross-sectional view showing a state where the workpiece 70 is provided with a collection channel 70a for preventing the UV resin 80 from overflowing. In this embodiment, the collection channel 70a is provided so as to circle the outer edge of the workpiece 70 so that the UV resin 80 pressed out toward the periphery of the workpiece 70 from the center of the workpiece 70 when the UV resin 80 is clamped between the nano-imprinting mold 30 and the workpiece 70 flows into the collection channel 70a.

The depth and width of the collection channel 70a are set so as to produce a sufficient capacity for holding the UV resin that has flowed into the collection channel 70a and the width of the collection channel 70a is set so as to prevent the UV resin 80 from being discharged outside the collection channel 70a due to the flow speed of the UV resin 80 flowing into the collection channel 70a. In the present embodiment the width of the collection channel 70a is set at 0.1 mm and the depth is set at 0.05 mm.

A stepped concave part 30c is provided in the nano-imprinting mold 30 so as to face the collection channel 70a so that a sufficient distance of separation is provided at the facing parts of the collection channel 70a and the nano-imprinting mold 30. If sufficient separation is provided between the collection channel 70a and the nano-imprinting mold 30 in this way, when the UV resin 80 flows into the collection channel 70a, it will be possible for the UV resin 80 to reliably enter the collection channel 70a of the workpiece 70. By curing the UV resin 80 that has been introduced into the collection channel 70a using light, it is possible to prevent contamination of the resin, such as when the workpiece 70 is conveyed. It is also possible to wash the UV resin 80 introduced into the collection channel 70a in a separate process.

### UV Curable Resin

Since the UV curable resin used in the present invention forms a predetermined convex/concave pattern on the surface of the workpiece 70 and such predetermined convex/concave pattern is etched to form a mask, there are cases where a filler such as silicon is mixed into the resin to improve the etching resistance of the resin. In this way, when using UV resin in which filler has been mixed, the distance of separation (i.e., the gap) between the workpiece 70 and the nano-imprinting mold 30 needs to be set and the size of the filler needs to be selected so as to ensure that the filler can flow in the separation (i.e., gap) between the surface of the nano-imprinting mold 30 and the surface of the workpiece 70.

FIG. 15B shows a state where filler whose diameter is one half of the distance of separation has been introduced into the gap between the workpiece 70 and the nano-imprinting mold 30. In this case, the fluidity of the filler 81 is maintained without the filler 81 becoming blocked inside the gap.

FIG. 15A shows how the filler 81 with an external diameter that is one third of the distance of separation becomes combined and locked up when the filler 81 is introduced into the gap between the workpiece 70 and the nano-imprinting mold 30. In this way, the filler 81 becomes blocked when the average particle diameter of the filler 81 is ⅓ of the gap.

In this way, when the filler diameter becomes around ⅓ of the thickness of the fluidized bed for the resin, the filler coagulates and as a result, a phenomenon occurs where the filler density rises and parts where the resin is depleted are formed across the entire thickness of the resin from the surface of the molded object. Such parts where the density of the filler is high and the resin component is depleted appear in petal shapes, and such petal-shaped parts are concentrically disposed so as to radiate from a center part, just like a sunflower.

Such molded products are non-uniform and therefore defective. It was understood through experimentation that this problem can be solved by setting the diameter of the filler at around ⅓ of the thickness of the molded product or below. Here, it is supposed that when the filler diameter is reduced, the positions of the petals are shifted toward the outside of the product, and when the diameter is reduced further, the petals do not occur within the product.

Accordingly, during semiconductor nano-imprinting, when the thickness of the thin parts of a molded product is 7 nm and the thickness of the thick parts is 20 nm, superior compression molding quality is achieved when the filler diameter is set at 4 nm and even higher molding quality can be expected when the filler diameter is set at 2 nm or below.

What is claimed is:

1. An imprinting method comprising steps of:
supporting a workpiece on a lower base of a support frame unit, which includes the lower base and an upper base fixed to tie bars erected on the lower base, and supporting a nano-imprinting mold on the upper base so that the workpiece and the nano-imprinting mold can be relatively moved toward and away from one another;
a step of supplying a UV-curable resin onto a surface of the workpiece supported on the lower base and then relatively moving the workpiece and the nano-imprinting mold so as to approach one another so that a mold surface of the nano-imprinting mold and the surface of the workpiece contact one another and the UV-curable resin is filled between the workpiece and the nano-imprinting mold; and
curing the UV-curable resin by irradiating the UV-curable resin with UV light.

2. An imprinting method according to claim 1,
wherein the workpiece is supported on a setting table and through-holes that are connected to a pumping/evacuating mechanism for gas are provided in a planar region of the setting table on which the workpiece is set,
after the UV-curable resin has been supplied onto the workpiece, one of the setting table and the nano-imprinting mold is moved to and stopped at a filling operation position where the mold surface of the nano-imprinting mold and the surface of the workpiece are apart,
gas is pumped toward a lower surface of the workpiece from the through-holes provided in the setting table by the pumping/evacuating mechanism and the workpiece is pressed onto the nano-imprinting mold from a center of the workpiece toward a periphery of the workpiece while gradually filling the UV-curable resin between the nano-imprinting mold and the workpiece, and
the UV-curable resin is cured by irradiating the UV-curable resin with UV light in a state where the workpiece is pressed onto the nano-imprinting mold by pumping pressure of the gas.

3. An imprinting method according to claim 2,
wherein a plurality of through-holes that are connected to the pumping/evacuating mechanism for gas are provided in the planar region of the setting table on which the workpiece is set, and
when gas is pumped from the through-holes to a lower surface of the workpiece, the gas starts to be pumped from a through-hole provided in the center of the setting table and then the gas is successively pumped from the through-holes located further out on the setting table.

4. An imprinting method according to claim 2,
wherein when the gas is pumped from the through-holes to a lower surface of the workpiece, the gas starts to be pumped in a state where an outer edge of the workpiece is held by vacuum suction on the setting table.

5. An imprinting method according to claim 1,
wherein as the workpiece, a workpiece that has a collection channel for preventing the UV-curable resin from overflowing from the workpiece when the UV-curable resin is filled between the workpiece and the nano-imprinting mold formed at an outer circumferential edge thereof is used.

6. A nano-imprinting apparatus comprising:
a support frame unit including a lower base and an upper base fixed to tie bars erected on the lower base;
a nano-imprinting mold supported on the upper base;
a setting table that is supported on the lower base and in which a plurality of through-holes are provided in a planar region on which a workpiece is set;
a raising/lowering mechanism that raises and lowers one of the nano-imprinting mold and the setting table;
a pumping/evacuating mechanism for gas that is connected to the through-holes and pumps gas and evacuates gas via the respective through-holes individually; and
a control unit for carrying out control that (i) drives, after the UV-curable resin has been supplied onto the workpiece, the raising/lowering mechanism to move one of the setting table and the nano-imprinting mold and to stop the one of the setting table and the nano-imprinting mold at a filling operation position where the mold surface of the nano-imprinting mold and the surface of the workpiece are separated, (ii) causes the pumping/evacuating mechanism for gas to start pumping the gas toward a lower surface of the workpiece from the through-holes provided in the setting table, (iii) next causes the pumping/evacuating mechanism to pump the gas successively from through-holes located further outside to press the workpiece onto the nano-imprinting mold from a center of the workpiece toward a periphery of the workpiece while gradually filling the UV-curable resin between the nano-imprinting mold and the workpiece, and (iv) has the UV-curable resin cured and imprinted by irradiating the UV-curable resin with UV light in a state where the workpiece is pressed onto the nano-imprinting mold by pumping pressure of the gas.

7. A nano-imprinting apparatus according to claim 6, wherein a plurality of through-holes are provided in the setting table in a layout that radiates from the center of the setting table.

8. A nano-imprinting apparatus according to claim 6, wherein a plurality of pockets with inner bottom surfaces formed as flat surfaces are provided in the setting table and the through-holes are provided in the respective inner bottom surfaces of the pockets.

9. A nano-imprinting apparatus according to claim 6, wherein through-holes that are connected to an air evacuating mechanism for evacuating air to pull an outer edge of the workpiece onto the setting table by suction are provided in the setting table.

10. A nano-imprinting apparatus according to claim 6, wherein the setting table 20 is provided with an alignment mechanism for moving the setting table in X-Y-θ directions to align the setting table with the nano-imprinting mold.

11. A nano-imprinting apparatus according to claim 6, wherein after the UV-curable resin has been clamped by the workpiece and the nano-imprinting mold and cured with UV light, control is carried out to pull the workpiece by vacuum suction onto the setting table using the pumping/evacuating mechanism for gas and to detach the workpiece that has been imprinted from the nano-imprinting mold by lowering the setting table toward a lower position.

12. A nano-imprinting apparatus according to claim 6, further comprising a workpiece conveying mechanism that carries out an operation that supplies the workpiece to and removes the workpiece from the setting table by holding the workpiece by suction on a suction pad,
wherein after the UV-curable resin has been clamped by the workpiece and the nano-imprinting mold and cured with UV light, control is carried out to lower the setting table in a state where the workpiece adheres to the nano-imprinting mold, to hold the lower surface of the workpiece on the suction pad, and to then detach the workpiece from the nano-imprinting mold and convey the workpiece by operating a robot.

13. A nano-imprinting apparatus according to claim 6, wherein the nano-imprinting mold is provided with protrusions that (i) are smaller than a distance of separation between a mold surface of the nano-imprinting mold and the workpiece when the workpiece has been raised to the filling operation position and (ii) limit a molded thickness of the UV-curable resin.

14. A nano-imprinting apparatus according to claim 6, wherein the nano-imprinting mold is provided with a collection channel that collects the UV-curable resin that is pressed out to an outer edge of the workpiece from the center of the workpiece when the workpiece is pressed onto the nano-imprinting mold.

15. A nano-imprinting apparatus according to claim 6, wherein the nano-imprinting mold is provided with pressing channels for adjusting the flow and maintaining flow characteristics of the UV-curable resin pressed out toward the outer edge of the workpiece from the center of the workpiece when the workpiece is pressed on to the nano-imprinting mold.
